(19) United States
(12) Patent Application Publication
(10) Pub. No.: US 2010/0082860 A1
(43) Pub. Date: Apr. 1, 2010

(54) SYSTEM AND METHOD FOR UPDATING THE STATUS OF AN ASYNCHRONOUS, IDEMPOTENT MESSAGE CHANNEL

(75) Inventor: Raghvendran Murthy, Bangalore (IN)

Correspondence Address: YAHOO! INC.;C/O Ostrow Kaufman & Frankl LLP, The Chrysler Building, 405 Lexington Avenue, 62nd Floor, NEW YORK, NY, 10174, US

(73) Assignee: YAHOO! INC., Sunnyvale, CA (US)

(21) Appl. No.: 12/239,358

(22) Filed: Sep. 26, 2008

(51) Int. Cl. G06F 13/42

(52) U.S. Cl. 710/105

(57) ABSTRACT

The present invention provides systems and methods for an abstraction layer for an asynchronous, idempotent message channel useful for performing status updates between communicating processes via a protocol that reduces overhead. The system comprises a sink endpoint that is operative to send a status message, a data path that is operative to transmit the status message over a message channel, a source endpoint that is operative to receive the status message sent by the sink endpoint over the data path, and an abstraction layer that is operative to provide an interface between the sink endpoint and the source endpoint over the message channel, relaying the status message from the sink endpoint to the source endpoint according to an optimized algorithm.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### FIELD OF THE INVENTION

The present invention provides methods, systems and computer program products for a protocol and an abstraction layer on a bidirectional communication channel for communicating unidirectional status updates.

### BACKGROUND OF THE INVENTION

A number of techniques are known to those of skill in the art for providing a status update mechanism on a message channel. In many parallel programs, for example, it is often the case that a process needs to periodically communicate its current status to other processes across a message channel.

On a traditional message channel, if the sender periodically or continuously sends status messages, it queues up in front of a slow receiver. This results in an inefficient process, as the receiver needs only the latest message transmitted. Additionally, systems and methods of the prior art generally provide for a receiver that polls the sender. In this instance where the receiver polls the sender, the receiver may be polling too soon, for example, when the status of the sender has not changed.

Thus the systems and methods of the prior art are limited in that both the send and the receive operations on a traditional messaging channel for the communication of status result in an inefficient communication protocol due to excessive message traffic.

To overcome shortcomings and problems associated with existing systems and methods for updating the status, an abstraction of an asynchronous, idempotent message channel is defined. Embodiments of the present invention provide systems and methods for creating an abstraction layer implemented as a communication protocol to reduce the messaging overhead on a standard message channel.

### SUMMARY OF THE INVENTION

The present invention provides systems and methods for updating the status on an asynchronous, idempotent message channel. According to one embodiment, the system comprises a sink endpoint that is operative to send a status message and receive an acknowledgement message and a source endpoint that is operative to receive the status message sent by the sink endpoint and send the acknowledgement message to the sink endpoint. The system further comprises a data path that is operative to transmit the status message and acknowledgment message over a message channel, a communication protocol between the sink and the source endpoint and an abstraction layer that is operative to provide an interface between the communicating application programs using the source and the sink endpoints over the message channel, by relaying the status message from the sink endpoint to the source endpoint according to an optimized algorithm.

The method according to the present embodiment comprises checking to see if the status of the message channel is free, setting the status of the message channel to busy if the status of the message channel is free, and sending a status message from a sink endpoint to a source endpoint across the message channel on a communication handle. The message is discarded if the status of the message channel is busy. The method in the same embodiment further comprises receiving a status message at a source endpoint and sending an acknowledgement message from the source endpoint to the sink endpoint across the message channel and changing the message channel status from busy to free upon receipt of acknowledgment at a sink endpoint.

According to another embodiment, the status message is stored in a buffer in the sink endpoint and checked to see if a status request message is received from the source endpoint. If a status request message is received, the status buffer is sent with the acknowledgment to the source endpoint across the message channel. The method in the same embodiment further comprises the source endpoint sending a message across the message channel to the sink endpoint and setting the channel status to busy. The status message along with the acknowledgement received at the source endpoint from the sink endpoint is copied to a buffer at the source endpoint. The message in the buffer can be provided to the operator of the source endpoint when the channel status is busy.

### BRIEF DESCRIPTION OF THE DRAWINGS

The invention is illustrated in the figures of the accompanying drawings which are meant to be exemplary and not limiting, in which like references are intended to refer to like or corresponding parts, and in which:

FIG. 1A is a block diagram presenting a system for implementing an abstraction of an asynchronous, idempotent message channel for propagation of a status message, according to one embodiment of the present invention;

FIG. 1B is a block diagram presenting a system for implementing an abstraction of an asynchronous, idempotent message channel for propagation of a status message with multiple source endpoints, according to one embodiment of the present invention;

FIG. 2 is a flow diagram presenting a method for implementing an abstraction of an asynchronous, idempotent message channel by performing a send operation at the sink endpoint in a stop-and-wait based protocol, according to one embodiment of the present invention;

FIG. 3 is a flow diagram presenting a method for implementing an abstraction of an asynchronous, idempotent message channel by performing a receive operation at the source endpoint in a stop-and-wait based protocol, according to one embodiment of the present invention;

FIG. 4 is a flow diagram presenting a method for implementing an abstraction of an asynchronous, idempotent message channel by performing a send operation at the sink endpoint in a shared-memory based protocol, according to one embodiment of the present invention; and

FIG. 5 is a flow diagram presenting a method for implementing an abstraction of an asynchronous, idempotent message channel by performing a receive operation at the source endpoint in a shared-memory based protocol, according to one embodiment of the present invention.

### DETAILED DESCRIPTION OF THE EMBODIMENTS

In the following description of the embodiments of the present invention, reference is made to the accompanying drawings that form a part hereof, and in which is shown by way of illustration specific embodiments in which the invention may be practiced. It is to be understood that other embodiments may be utilized and structural changes may be made without departing from the scope of the present invention.

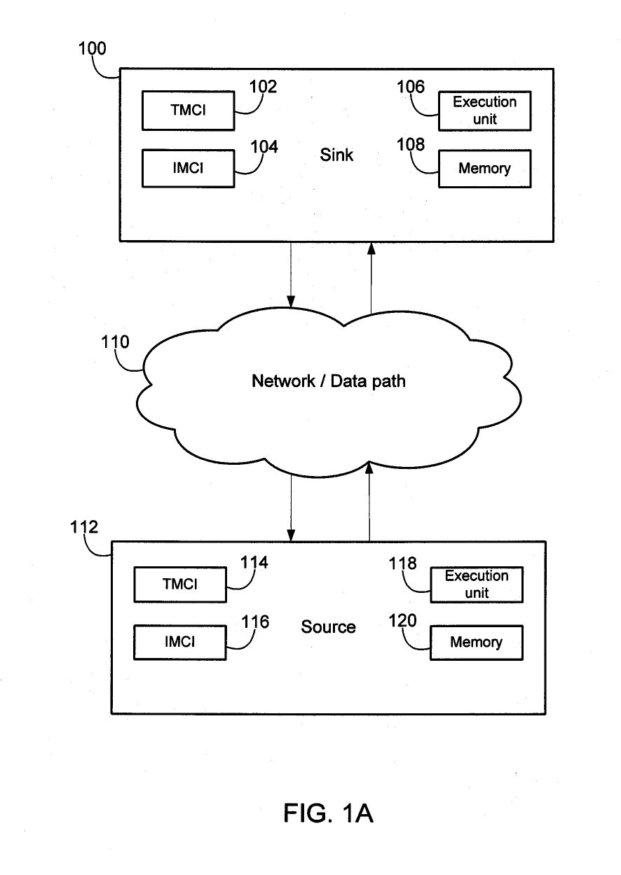

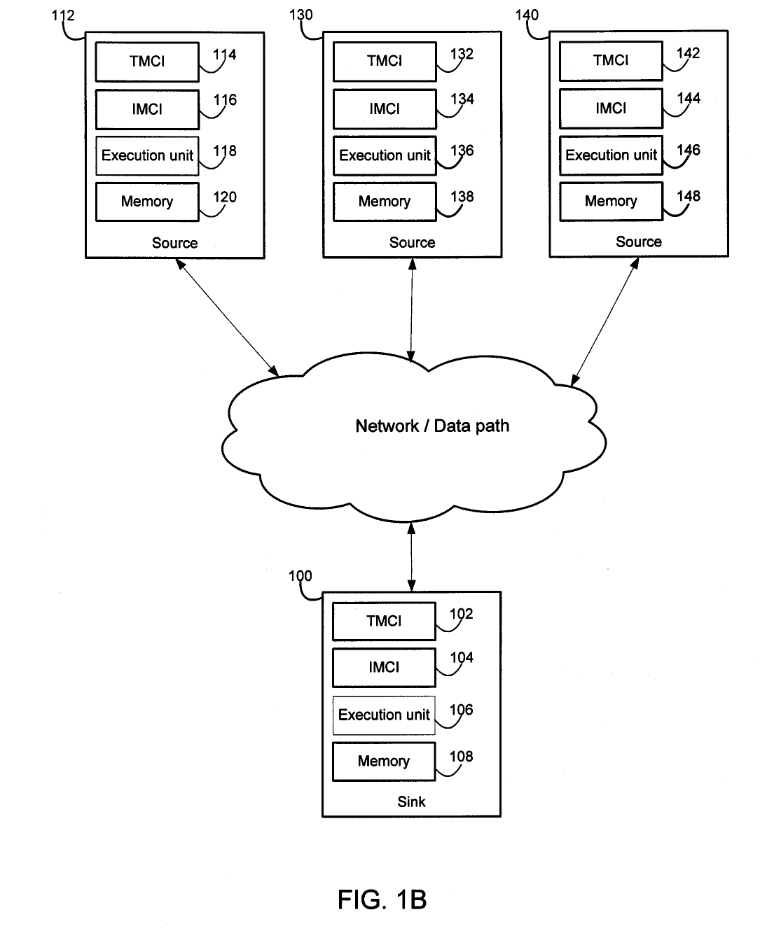

FIG. 1A presents a block diagram depicting a system for updating the status on an asynchronous, idempotent message channel, according to one embodiment of the present invention. In the embodiment of FIG. 1A, a sink endpoint 100 comprises one or more software or hardware components operative to facilitate sending a message signal including, but not limited to, a Traditional Message Channel Interface (“TMCI”) 102, an Idempotent Message Channel Interface (“IMCI”) 104, an execution unit 106, and a memory 108. The system may also comprise a source endpoint 112, which is communicatively coupled to the sink endpoint 100 via a network/datapath 110, and may comprise one or more software or hardware components operative to facilitate receiving a message signal including, but not limited to, a TMCI 114, an IMCI 116, an execution unit 118, and a memory 120.

The TMCIs 102 and 114 may comprise standard channel-based protocol interfaces over which the sink endpoint 100 communicates with the source endpoint 112. According to one embodiment, the TMCIs 102 and 114 communicate over a bidirectional link between a sink endpoint 100, which comprises a writing end to generate a status message, and a source endpoint 112, which comprises a reading end to interpret the status message from the sink endpoint 100. In this embodiment, the underlying communication channel provides for bidirectional ordered message transmission and delivery, for example, a socket. The TMCIs 102 and 114 may be implemented as software objects or hardware constructs identifying the current status of a process running either on the sink endpoint 100 or the source endpoint 112.

The IMCIs 104 and 116 overlay the TMCIs 102 and 114 respectively, as an abstraction layer comprising a unidirectional channel implemented over a bidirectional channel between the TMCI 102 of the sink endpoint 100 and the TMCI 114 of the source endpoint 112. The IMCIs 104 and 116 operate as a communication protocol to optimize the transmission of messages originating from the TMCI 102 of the sink endpoint 100, which are sent to the TMCI 114 of the source endpoint 112. According to one embodiment, the IMCIs 104 and 116 handle a single message at a given instance in time. For reception of an acknowledgement message at the source endpoint 112, at least one status message may be transmitted to the sink endpoint 100, or else the receive operation blocks further operation on the source endpoint 112.

According to an alternate embodiment, the IMCIs 104 and 116 operate as a shared-memory, where the receive operation on the source endpoint 112 returns a message without waiting for a communication acknowledgement from the sink endpoint 100. The source endpoint 112 returns an acknowledgement message even if no intervening status messages are sent. According to one embodiment, the source endpoint 112 receives a different status message depending on whether intervening send operations have occurred on the sink endpoint 100 between receive operations.

According to one embodiment of the present invention, the individual messages sent to the source endpoint 112 are not distinguished. The sink endpoint 100 sends the message in a non-blocking and asynchronous operation, e.g., operation completion does not depend on the success of the message transmission or remote delivery or remote reception. Once a message is considered for transmission, the IMCI 104 discards further sends without transmission until the IMCI 116 acknowledges the current transmission. For example, a time server that transmits messages with the current time is one potential application of such a message channel.

The execution units 106 and 118 process the message send and message receive operations inherent in a transmission and reception of status and acknowledgment messages between the source 100 and the sink 112. According to one embodiment, an execution unit comprises a Central Processing Unit (CPU), for example an Intel Pentium 4 processor. According to an alternate embodiment, the execution unit comprises a software algorithm residing within an application or computer operating system.

The memories 108 and 120 provide for the storage of program code or instructions for execution by the execution units 106 and 118, as well as the messages transmitted over the TMCIs 102 and 114 and the IMCIs 104 and 116. According to one embodiment of the present invention, a given memory 108 and 120 comprises physical transient memory, for example Random Access Memory (RAM). According to an alternate embodiment, the memory comprises virtual memory within an application or operating system itself. Embodiments of the invention may also utilize other persistent and transient memories known to those of skill in the art.

Various embodiments of the channel structure are possible. According to one embodiment, the network/data path 110 comprises a connection over one or more local or wide area networks, such as the Internet. According to an alternate embodiment, the network/datapath 110 comprises an internal communication bus on a client device. A client device, may, for example, comprise a general purpose personal computer comprising a processor, transient and persistent storage devices, input/output subsystem and a PCI bus to provide a communications path between components comprising the general purpose personal computer. For example, a 3.5 GHz Pentium 4 personal computer with 512 MB of RAM, 100 GB of hard drive storage space and an Ethernet interface to a network. Other client devices are considered to fall within the scope of the present invention including, but not limited to, hand held devices, set top terminals, mobile handsets, etc.

According to one embodiment, the channel comprises a single source endpoint 112 and a single sink endpoint 100. An alternate embodiment is depicted in FIG. 1B, where the channel comprises a single sink endpoint 100 and multiple source endpoints 112, 130, and 140. Such an embodiment of the channel enables the multicast transmission of a message from the TMCI 102 of the sink endpoint 100 to the TMCIs 114, 132, and 142 at the source endpoints 112, 130, and 140, respectively. When the sink endpoint 100 considers a new status update message for transmission, the IMCI 104 checks that the source endpoints 112, 130, and 140 transmit an acknowledgement message with the same content. The IMCIs 134 and 144 are substantially analogous in functionality to IMCI 116 as described above in FIG. 1A. Similarly, the execution units 136 and 146, and memories 138, and 148, are substantially analogous in functionality to the execution unit 118 and memory unit 120.

Referring now to the technical functionality of the IMCI represented as pseudo-code, according to one embodiment, the “send status update” call is identified below in Table A:

TABLE A

channel_status = send_status_update
(status_message, operation_status)

The abovementioned “operation_status” variable indicates either: (1) accepted for delivery where the current message is accepted for transmission; or (2) not accepted where the current message is not accepted for transmission either because the channel is busy or because of an erroneous condition on the channel. The “channel_status” variable indicates either: (1) the channel is ok where the channel is functioning properly; or (2) channel error where the channel is not functioning properly and the current message is not accepted for transmission (in addition, the previous message may or may not have been delivered). The “send status update” call does not block for receiving the acknowledgment message according to most configurations of abstraction layer embodiments and channel structures.

According to another embodiment, the “receive status update” call is identified below in Table B:

TABLE B
channel_status = receive_update (message_buffer, operation_status)

The abovementioned “operation_status” variable indicates either: (1) receive successful where a message is successfully received; or (2) receive unsuccessful where a message receipt fails. The “channel_status” variable indicates either: (1) the channel is ok where the channel is functioning properly; or (2) channel error where the channel is not functioning properly. The “receive status update” call according to some embodiments blocks for receiving the acknowledgement messages, including, but not limited to, a ‘single message/single source and sink’ configuration, and a ‘single message/multiple source and single sink’ configuration. The call returns a message without blocking for the embodiments comprising a shared memory protocol with ‘single source and single sink’ configuration, and a shared memory protocol with ‘multiple source and single sink’ configuration.

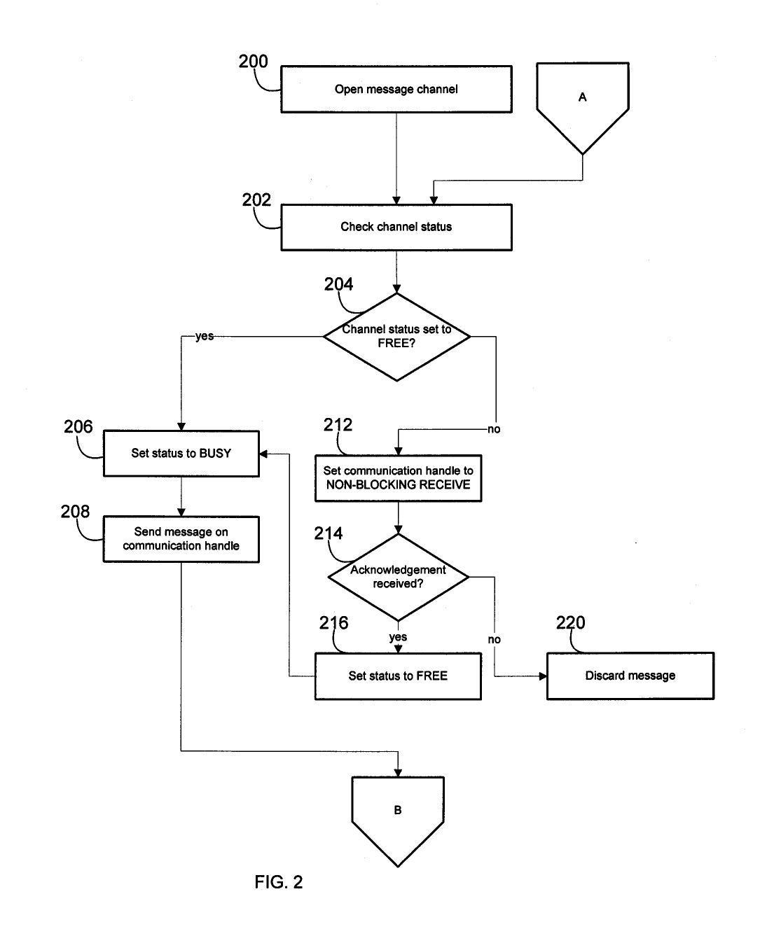

A method for using the systems of FIGS. 1A and 1B to update the status of an idempotent message channel through a send operation at the sink endpoint in a stop-and-wait based protocol is illustrated in the flow diagram of FIG. 2. According to the method of FIG. 2, a message channel is opened, step 200. Returning to the illustrative example of a time server, the server opens a message channel to relay the current time to a given software application, software process or hardware construct. According to the embodiment of FIG. 2, the message channel comprises a communication link between the time server (sink) and the exemplary software application (source). The status of the channel is then checked, step 202. According to one embodiment, there are two potential status flags for the channel: FREE and BUSY. When the channel status is set to FREE, step 204, a message may be transmitted. The status is then set to BUSY, step 206, and the message is sent on a communication handle, step 208. The communication handle transmits and receives messages on the underlying channel. For example, the time server sets the channel to BUSY and transmits a message of the current time to the software application via the communication handle.

If however, the channel status is not free, the communication handle is set to NON-BLOCKING RECEIVE, step 212. According to one embodiment, the channel status is not free when a status message has been transmitted and acknowledgement message is pending to be received. For example, the time server checks for an acknowledgement message from the software application at the remote end that it has received the current time. Upon receipt of an acknowledgment message, step 214, the channel status is set to FREE, step 216. The status is then reset to BUSY, step 206, and the status message is sent on the communication handle, step 208. If however, acknowledgement is not received, then the current status message is discarded, step 220.

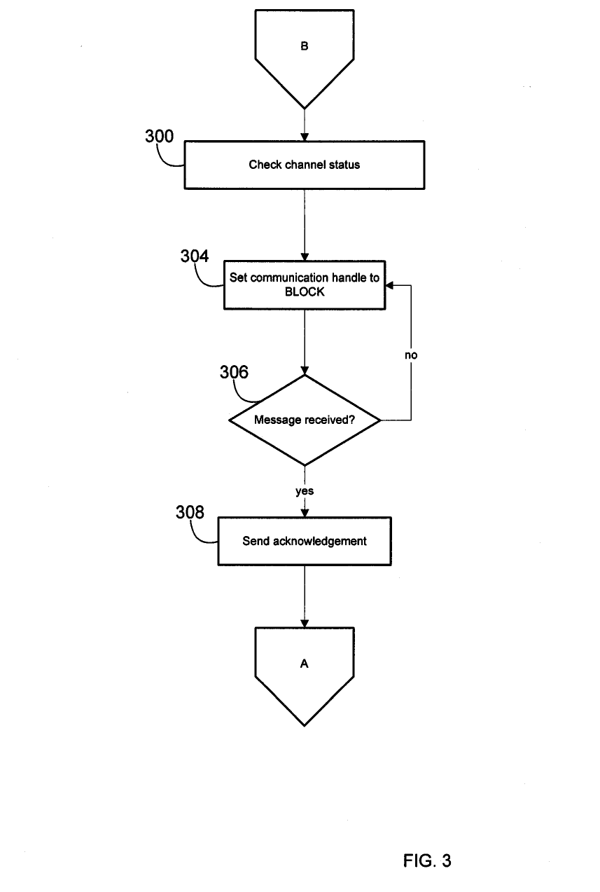

FIG. 3 presents a flow diagram illustrating a method for performing a receive operation at the source endpoint to receive the status of a message channel in a stop-and-wait based protocol, according to one embodiment of the present invention. According to the embodiment depicted in FIG. 3, the receiving source endpoint state status flags are either OK (indicating that the channel status is open and working) or ERROR (indicating that an error has occurred on the underlying channel). Continuing from receive status message operation at the source endpoint, the channel status is checked and the application waits for a status message, step 300. For example, the software application checks to see if the channel to the time server is functioning properly. The communication handle is set to BLOCK, step 304. If a status message is then received, step 306, an acknowledgement message is sent, step 308. For example, upon receipt of the current time from the time server, the software application sends an acknowledgment message to the communication handle. The process then returns to the send operation of FIG. 2. If a message is not received, step 306, then the method cycles back to step 304.

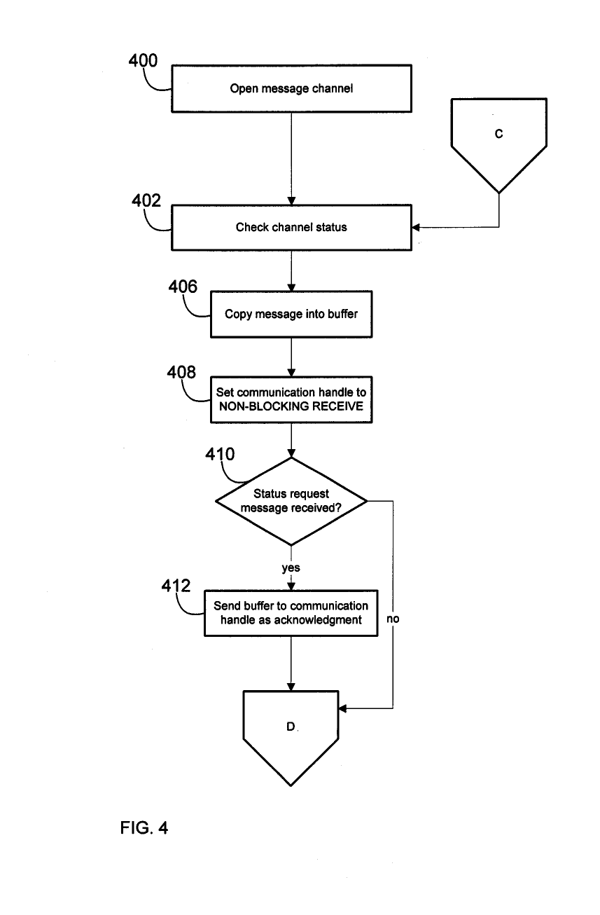

FIG. 4 presents a flow diagram depicting a method for performing a send operation on the sink endpoint to update the status of a message channel in a shared-memory based protocol, according to one embodiment of the present invention. As illustrated in the embodiment, the message channel is opened, step 400. The channel status is checked, step 402, and if the channel status is OK, then the message is copied into the buffer, step 406. The buffer temporarily stores the status and status request acknowledgement message until ready for processing. The communication handle is set to NON-BLOCKING RECEIVE, step 408, and a check is performed to see if any status request message has been received, step 410.

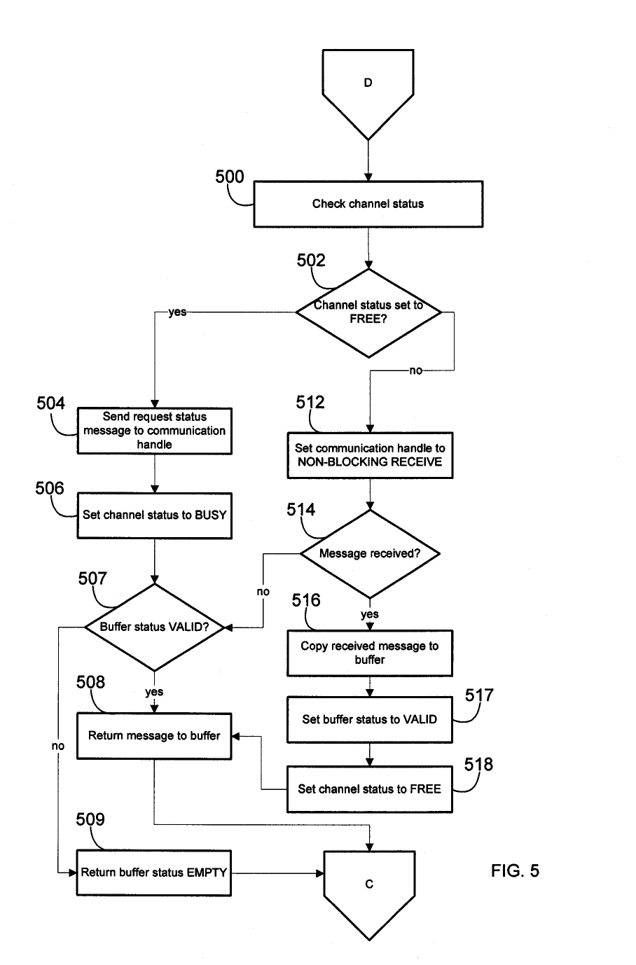

If the status request message has been received, step 410, the data in the buffer may be sent to the communication handle as an acknowledgment message, step 412. The method then proceeds to the receive operation on the source endpoint of FIG. 5. If, however, the status request message has not been received, step 410, then the send operation returns.

FIG. 5 presents a flow diagram illustrating a method for performing a receive operation on the source endpoint to receive the status of a message channel in a shared-memory based protocol, according to one embodiment of the present invention. In the embodiment of FIG. 5, there are two potential status flags for the channel: FREE and BUSY. Additionally there are two potential status flags for the buffer: VALID or EMPTY. The channel status is checked, step 500. If the channel status is set to FREE, step 502, then a status request message is sent to the communication handle, step 504. The channel status is then set to BUSY, step 506, and a check is performed to see if the buffer status is set to VALID, step 507. If the status of the buffer is set to VALID, the status message in the buffer maybe returned to the application, step 508. If the buffer status is not set to VALID, then the receive operation may return the buffer status as EMPTY, step 509.

If the channel status is not set to FREE, step 502, then the communication handle is set to NON-BLOCKING RECEIVE, step 512, and check is performed to determine if any acknowledgement to the status request message has arrived. Upon receipt of a status message, step 514, the received message is copied to the buffer, step 516, and the buffer status is set to VALID, step 517. The channel status is then set to FREE, step 518, and the process cycles back to step 508, where the copied buffer is returned to the application. If the message is not yet received in step 514, the buffer status is checked for its validity, step 507 and the method proceeds from step 507 as already described.

While the invention has been described and illustrated in connection with multiple embodiments, many variations and modifications as will be evident to those skilled in this art may be made without departing from the spirit and scope of the invention, and the invention is thus not to be limited to the precise details of methodology or construction set forth above as such variations and modification are intended to be included within the scope of the invention.

FIGS. 1A through 5 are conceptual illustrations allowing for an explanation of the present invention. It should be understood that various aspects of the embodiments of the present invention could be implemented in hardware, firmware, software, or combinations thereof. In such embodiments, the various components and/or steps would be implemented in hardware, firmware, and/or software to perform the functions of the present invention. That is, the same piece of hardware, firmware, or module of software could perform one or more of the illustrated blocks (e.g., components or steps).

In software implementations, computer software (e.g., programs or other instructions) and/or data is stored on a machine readable medium as part of a computer program product, and is loaded into a computer system or other device or machine via a removable storage drive, hard drive, or communications interface. Computer programs (also called computer control logic or computer readable program code) are stored in a main and/or secondary memory, and executed by one or more processors (controllers, or the like) to cause the one or more processors to perform the functions of the invention as described herein. In this document, the terms “machine readable medium,” “computer program medium” and “computer usable medium” are used to generally refer to media such as a random access memory (RAM); a read only memory (ROM); a removable storage unit (e.g., a magnetic or optical disc, flash memory device, or the like); a hard disk; electronic, electromagnetic, optical, acoustical, or other form of propagated signals (e.g., carrier waves, infrared signals, digital signals, etc.); or the like.

Notably, the figures and examples above are not meant to limit the scope of the present invention to a single embodiment, as other embodiments are possible by way of interchange of some or all of the described or illustrated elements. Moreover, where certain elements of the present invention can be partially or fully implemented using known components, only those portions of such known components that are necessary for an understanding of the present invention are described, and detailed descriptions of other portions of such known components are omitted so as not to obscure the invention. In the present specification, an embodiment showing a singular component should not necessarily be limited to other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present invention encompasses present and future known equivalents to the known components referred to herein by way of illustration.

The foregoing description of the specific embodiments will so fully reveal the general nature of the invention that others can, by applying knowledge within the skill of the relevant art(s) (including the contents of the documents cited and incorporated by reference herein), readily modify and/or adapt for various applications such specific embodiments, without undue experimentation, without departing from the general concept of the present invention. Such adaptations and modifications are therefore intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance presented herein, in combination with the knowledge of one skilled in the relevant art(s).

We claim:

1. A system for implementing an abstraction of an asynchronous, idempotent message channel for propagation of a status message, the system comprising:
a sink endpoint operative to send the status message and receive an acknowledgement message;
a source endpoint operative to receive the status message sent by the source endpoint and send the acknowledgement message to the source endpoint;
a data path operative to transmit the status message and the acknowledgment message over a message channel;
a communication protocol between the sink endpoint and the source endpoint that optimizes the communication traffic between the sink endpoint and the source endpoint for status propagation from an application component using the sink endpoint to an application component using a corresponding source endpoint; and
an abstraction layer operative to provide an interface between the sink endpoint, the source endpoint and the application components by relaying the status message from the sink endpoint to the source endpoint according to an optimized algorithm.

2. The system of claim 1, wherein the abstraction layer comprises a stop-and-wait algorithm, where a subsequent status message is not sent over the message channel if a previous status message is not acknowledged.

3. The system of claim 1, wherein the abstraction layer comprises a shared-memory algorithm.

4. The system of claim 1, wherein a sink endpoint sends a status update message to a plurality of source endpoints.

5. The system of claim 1, wherein a sink endpoint send a status message to a plurality of source endpoints.

6. The system of claim 1, wherein a channel operation by the sink endpoint is asynchronous to the source endpoint.

7. The system of claim 1, wherein the status update messages are received by the source endpoint only when the source endpoint is ready to receive status update messages.

8. A method for implementing an abstraction of an asynchronous, idempotent message channel by performing a send operation on the sink endpoint to update status, the method comprising:
checking to see if the status of the message channel is free;
setting the status of the message channel to busy if the status of the message channel is free; and
if the message channel is free, sending a status message from a sink endpoint to a source endpoint across the message channel on a communication handle, otherwise discarding the status message.

9. The method of claim 8, further comprising checking for an error on the message channel.

10. The method of claim 8, wherein the send operation is performed according to a stop-and-wait algorithm.

11. The method of claim 8 further comprising a receive operation for receiving the status message at the source endpoint on the message channel, the method further comprising:
checking if the status of the message channel is set to OK;
performing a blocking receive on the communication handle to receive the status message;
completing the receive operation by returning the status message content as a status update;
sending an acknowledgement message to the sink upon receipt of the status message.

12. A method for implementing an abstraction of an asynchronous, idempotent message channel by performing a send operation to update status, the method comprising:
checking to see if the status of a message channel is set to OK;
copying the content of a status message to a memory buffer;
performing a non-blocking receive operation on a communication handle; and
if the receive operation succeeded in providing a status request from a source endpoint, copying the memory buffer to a message; and
acknowledging the status request from the source endpoint with a status update message.

13. The method of claim 12, further comprising:
checking the status of the message channel at the source endpoint to see if the channel is busy;
if the channel is not busy, sending a status request message from the source endpoint to a sink endpoint;
performing a non-blocking receive operation;
if the receive operation is successful, copying the content of the status message to a memory buffer and setting the buffer status to VALID;
changing the status of the message channel from busy to free; and
completing the receive operation by providing the memory buffer content, if the status of the buffer is valid, otherwise returning a status of empty.
If the channel is busy, completing the receive operation by providing the memory buffer content, if the status of the buffer is valid, otherwise returning a status of empty.

14. Computer readable media comprising program code for execution by a programmable processor to perform a method for implementing an abstraction of an asynchronous, idempotent message channel by performing a send operation to update status, the program code comprising:
program code for checking to see if the status of the message channel is free;
program code for setting the status of the message channel to busy if the status of the message channel is free; and
program code for sending a status message from a sink endpoint to a source endpoint across the message channel on a communication handle.

14. The computer readable media of claim 13, further comprising program code for checking for an error on the message channel.

15. The computer readable media of claim 13, wherein the send operation is performed according to a stop-and-wait algorithm.

16. The computer readable media of claim 13, wherein the send operation is performed according to a shared-memory algorithm.

17. The computer readable media of claim 16, wherein the status message is copied into a buffer.

18. The computer readable media of claim 13, further comprising program code for performing a receive operation, the program code further comprising:
program code for receiving a status update message at a source endpoint;
program code for setting a communication handle to block further status messages from reaching the source endpoint;
program code for sending an acknowledgement message from the source endpoint to the communication handle; and
program code for changing the message channel status from busy to free upon receipt of acknowledgment at a sink endpoint.
